(19) United States
(12) Patent Application Publication
(10) Pub. No.: US 2022/0406209 A1
(43) Pub. Date: Dec. 22, 2022

(54) Advanced Audiovisual Presentation System

(71) Applicant: Matthew Anderson, La Mesa, CA (US)

(72) Inventor: Matthew Anderson, La Mesa, CA (US)

(73) Assignee: Learning Glass Solutions, Inc., San Diego, CA (US)

(21) Appl. No.: 17/351,087

(22) Filed: Jun. 17, 2021

(51) Int. Cl. G09B 5/06; G09B 5/14; H04N 5/72

(52) U.S. Cl. CPC G09B 5/06; G09B 5/14; H04N 5/72

(57) ABSTRACT

Method and apparatus for presenting audio and visual information to an audience by streaming, broadcast, live and recording presentations including a generally transparent pane having one end disposed proximate an end of a reflective pane to form an apex with an acute angle. In use an imaging device is disposed between the generally transparent pane and the reflective pane and oriented to image a reflection of the generally transparent pane off of the reflective pane. In operation a lecturer positions themselves in front of the generally transparent pane and performs an audio and visual presentation by writing written material on the surface of the generally transparent pane facing the lecturer. The imaging device, imaging a reflection of the generally transparent pane off the reflective pane, images a left-to-right reversal of the writing on the generally transparent pane thereby rendering it readable by a viewer.

### BACKGROUND OF THE INVENTION

The present invention pertains to methods and apparatus for the presentation of audio and visual information by a lecturer, said presentation generally intended to be either broadcast and/or recorded for later viewing.

Traditionally the presenting of information to an audience in various settings have required some means for presenting both audio and visual information by a lecturer. Lecturers in higher education are an example of one such application. One of the first apparatus to accomplish this task is the blackboard, alleged to have first been introduced in about 1801 by James Pillans, a headmaster and geography teacher at the Old High School in Edinburg, Scotland. Headmaster Pillans' innovative use of slate sheets upon which he could present visual information by writing upon the slate with a piece of chalk was rapidly adopted and by 1809 it is believed most public schools in metropolitan areas used blackboards in teaching, although the term “blackboard” itself is not considered to have been generally adopted until about 1815.

The next advancement in the method and apparatus of presenting both audio and visual information by a lecturer is believed to have occurred in the early 1960's when the use of slate to form a conventional blackboard were replaced by what came to be called a “greenboard” comprising a steel plate coated with a porcelain-based enamel. This enamel coating approach was considered an improvement because chalk powder could be more easily removed from the greenboard material compared to a sheet of slate and because the green color was considered more pleasing and easier on viewer's eyes than the stark black or dark grey of conventional slate blackboards. The greenboard was also regarded as more durable than the relatively fragile sheets of slate previously used with conventional blackboards and further regarded as lighter in weight, thereby reducing shipping costs.

The use of chalk was eventually eliminated in some settings with the introduction in the 1980's of the so-called “whiteboard” comprising dry erase board used in combination with certain types of ink markers. With the introduction of the whiteboard chalk was no longer required for use by the lecturer and the clouds of chalk dust associated therewith was beneficially eliminated. By the mid 1990's many colleges and universities in the United States and elsewhere had switched entirely over to whiteboards.

All of these various blackboards, greenboards and whiteboards, however, suffer from one unavoidable and highly noticeable disadvantage; the lecturer has to turn their back on their audience in order to write visual information upon the board. Audience are estimated to view only the posterior of their lecturer for up to half the time the lecturer is making their presentation. Numerous patents have issued for various systems configured to image written material contemporaneously written by a lecturer during an audio-visual presentation, although typically at the expense of foregoing imaging of the lecturer making the audio-visual presentation. U.S. Pat. No. 10,523,893 solved this problem in a studio setting, enabling a lecturer to face an audience viewing an audio-visual presentation by broadcast or recorded viewing by affording a camera imaging the lecturer through a transparent surface upon which a lecturer would write visual material with an appropriate ink marker along with circuitry for reversing the left-right orientation of that writing. While solving the two-hundred-year-old problem of having a lecturer facing away from their audience, the U.S. Pat. No. 10,523,893 solution still required the use of sophisticated equipment and a video studio to effectuate. The present invention solves these and other limitations of the prior art.

### BRIEF SUMMARY OF THE INVENTION

The present invention overcomes the deficiencies of the prior art by providing methods and apparatus enabling a lecturer to present both audio and visual to an audience without requiring the lecturer to turn away from an audience to write written material upon a presentation surface and without necessitating the use of sophisticated equipment and a video studio to effectuate.

One embodiment of the present invention comprises a visual presentation system enabling audio and visual presentations by a lecturer with an imaging device. The invention includes a generally transparent pane and a reflective pane, the reflective pane having one end disposed adjacent an end of the generally transparent pane to form an acute angle. The lecturer is able to write written material on a surface of the generally transparent pane facing towards them. When the imaging device is oriented to image reflections of the written material off the reflective pane, the written material is imaged with a legible left-to-right orientation and the lecturer is observed behind the written material. The imaging device used on conjunction with the present invention may be any conventional smart phone such as an Apple brand i-Phone or an Android brand type of smart phone or a tablet-like device such as an Apple brand iPad or, alternatively, a video camera for recording and/or transmission device.

According to one embodiment of the method of the present invention a lecturer presents both audio and visual material to an audience by providing a generally transparent pane and a reflective pane disposed adjacent the generally transparent pane, the lecturer then making a presentation both verbally and by writing written material on a surface of the generally transparent screen facing the lecturer, and imaging the lecturer making the presentation by using an imaging device oriented to image a reflection of the lecturer and a reflection of the written material off of the reflective pane, the reflection of the written material being imaged in the reflection with a legible left-to-right orientation.

In yet another embodiment of the present invention an apparatus enabling audio and visual presentations by a lecturer comprises a generally transparent pane, a reflective pane pivotally coupled to one end of the generally transparent screen, and a base element contacting an end of the generally transparent pane and an end of the reflective pane, said base element being pivotally coupled to one of the generally transparent pane and the reflective pane.

The foregoing and further advantages, features and principles of the present invention will become more readily apparent from the following detailed description of several preferred embodiments of the present invention detailed below, with reference to the accompanying drawings.

### BRIEF DESCRIPTION OF THE DRAWINGS

FIG. 1 is a side view of one embodiment of the present invention.

FIG. 2 is a view of a lecturer and written information written on the generally transparent pane of the present invention by the lecturer as viewed through the generally transparent pane.

FIG. 3 is a view of an image of the lecturer and written information on the generally transparent pane of the present invention by the lecturer as viewed by an imager oriented toward the reflective pane.

FIG. 4 is a view of an alternative embodiment of the present invention.

FIG. 5 is a view of an alternative embodiment of the present invention when configured for ease of transport.

### DETAILED DESCRIPTION

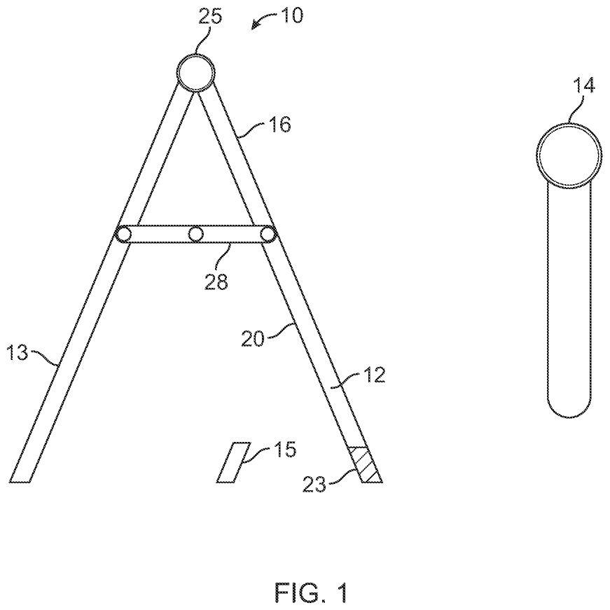

Referring to the figures, and more particularly FIG. 1 thereof, there is shown one embodiment of the present invention 10. As shown in FIG. 1 this embodiment of the present invention 10 includes a generally transparent pane 12 and a reflective pane 13 having one end thereof disposed adjacent an end of the generally transparent pane 12 so as to form an acute angle at an apex, the point of closest proximity between the generally transparent pane 12 and the reflective pane 13. In one embodiment of the present invention, the acute angle formed between the generally transparent pane 12 and the reflective pane 13 is in a range between approximately 40 degrees and 70 degrees, although excursions beyond this range of angles may be used without exceeding the scope of the present invention. In one presently preferred embodiment of the present invention the apex optimally forms a 48-degree angle between the generally transparent pane 12 and the reflective pane 13. Used in connection with the present invention is an imaging device 15 disposed between a bottom of the generally transparent pane 12 and the reflective pane 13. In in one embodiment of the present invention the imaging device 15 is oriented so as to generally face towards the reflective pane 13 at an angle of about 45-degrees from a horizontal orientation. Of course, differing angles or orientation of the imaging device 15 may be employed without departing from the scope of the present invention.

The generally transparent pane 12 may be fabricated from any of a variety of glass or plastic materials. In one presently preferred embodiment the generally transparent pane 12 is made of Starphire brand glass material. The generally transparent pane 12 may further be mounted in a frame 17 encasing edges of the generally transparent pane 12 so as to protect those edges from blows that could potentially chip the generally transparent pane 12, particularly during transport from one location to another. In a preferred embodiment of the present invention the reflective pane 13 includes a first surface reflective mirror. Second surface reflective mirrors, however, may also be employed without departing from the scope of the present invention.

The imaging device 15 may comprise any of the type of now relatively commonplace smart phones and tablet devices capable of transmitting both audio and visual information via a variety of means such as Wi-Fi, Bluetooth, cellular or via other communication modalities. Apple i-Phone brand smart phones and Android brand smart phones, and generally functionally similar tablet devices, such as the Apple i-Pad and the Microsoft Slate, are all examples of suitable imaging devices 15. Of course, other types of imaging devices may be employed in connection with use of the present invention such as, for example, a simple audio-visual video recording or transmission device capable of recording and/or transmitting a presentation by the lecturer 14 for contemporaneous and/or later transmission by other modalities.

In operation the present invention 10 is positioned on a support structure (not shown) such as a table of other supporting surface and the imaging device 15 is placed upon the support structure and oriented so as to capture an image reflecting off of the reflective pane 13. A lecturer 14 may then position themselves facing towards the transparent pane 12 and write written material upon a first surface 16 of the generally transparent pane 12 facing towards the lecturer with a marker pen (not shown) to present both audio and visual information to one or more viewers of the imaging device 15, or viewers of a recording made using the imaging device 15. The imaging device 15 may be configured to either transmit the image of the written material and the lecturer 14 or to record the same.

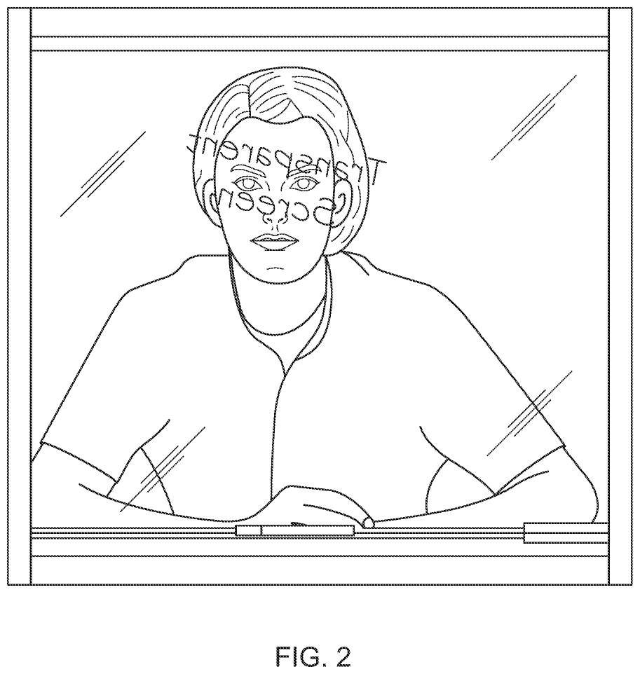

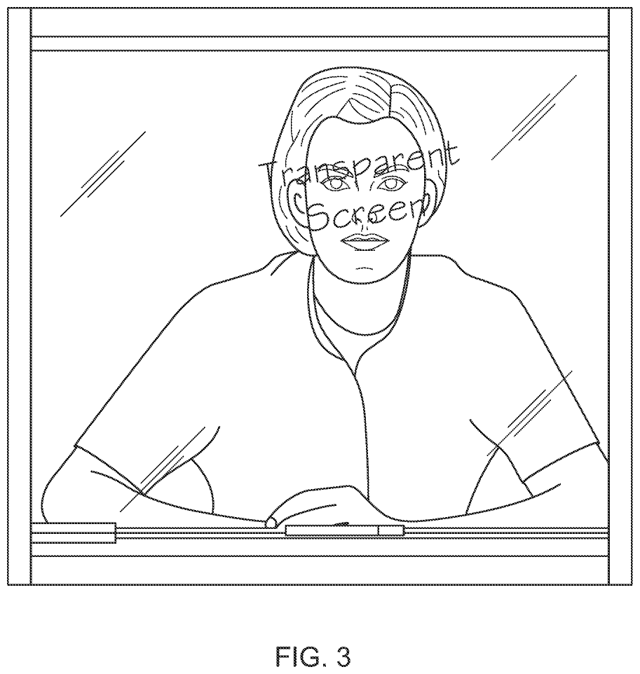

As shown in FIG. 2, if the lecturer 14 were simply imaged by orienting the imaging device 15 towards a second rear surface 20 of the generally transparent pane 10 (the surface opposite the surface 16 of the generally transparent pane 12 facing the lecturer 14) then any written material written by the lecturer 14 on the facing surface 16 of the generally transparent pane 12 would appear to a viewer as being reversed in left-to-right orientation. Since most viewers are not experienced reading reversed text the written material would appear essentially unreadable. As shown in FIG. 3, however, by orienting the imaging device 15 so as to capture an image of the lecturer 14 and of the written material reflecting off of the reflective pane 13 the reflection of the written material imaged by the imaging device 15 is reversed in left-to-right orientation, so as to render the written material (written by the lecturer on the facing surface 16) legible with a correct left-to-right orientation.

Because smart phones and tablet devices suitable for use with the present invention now typically, but not necessarily always, include both a rearward facing camera and a forward facing camera, the imaging device 15 used in connection with the present invention may be oriented in a variety of different orientations depending upon the desires of the lecturer. For example, with smart phones and tablet devices which project an image on its screen of an image being captured by the imaging device, the screen-side of the imaging device 15 may be oriented generally vertically with respect to the generally transparent pane 12 and the reflective pane 13 with the imaging device 15 employing its rearward facing camera (i.e. the camera facing away from the lecturer 14). This orientation of the imaging device 15 combined with use of the rearward facing camera enables the lecturer to observe on the screen of the smart phone or tablet the image being sent to the lecturer's audience (and/or being recorded for subsequent presentation) so as to better gauge the visual impact of their audio and visual presentation. Any and all such orientations of the imaging device 15 relative to the reflective pane 13 are within the scope of the present invention.

The present invention affords numerous advantages over conventional methods for lecturers to present both audio and visual written material to viewers. Among these advantages is the elimination of any need for a film or videography studio to support the lecturer's presentation of audio and visual material. In additional embodiments of the present invention further detailed below the current invention 10 may be configured to collapse into an easily transportable self-contained package. This is a substantial advantage in an era where pandemic conditions have or may again arise necessitating cancellation of in-person forms of teaching classrooms full of students and reliance upon remote teaching under broadcast “television” type conditions. Further where self-quarantining of the lecturer may become necessary for a period of time teaching can continue with the use of the present invention from the lecturer's quarantine venue.

In a further embodiment of the present invention also depicted in FIG. 1 a light source 23 may, but need not necessarily, be affixed to an edge of the generally transparent pane 12 to inject light into the generally transparent pane 12. This light source may advantageously be of generally blue light at a wavelength of predominantly, although not necessary exclusively, at about 405 nanometers. When used with fluorescent ink type marker pens, such as the Expo Neon brand of dry erase marker, the written material on the generally transparent pane 12 will be beneficially vivid and brilliant, aiding a viewer's attention to the written material. Differing colors may be employed by the lecturer to emphasize or distinguish differing parts of the written material. The light source 23 may comprise light emitting diodes (“LEDs”) emitting light at around 405 nanometers. Alternatively, the light source 23 may be a white light source used alone, or in combination with a filter selected to limit the wavelength of light injected into the generally transparent pane 12 to around 405 nanometers.

In another embodiment of the present invention further depicted in FIG. 1 the generally transparent pane 12 or the frame 17 may be pivotally coupled to the reflective pane 13 via a pivotal coupling 25, such as a hinge, at the apex. Use of this pivotal coupling provides for collapse of the invention 10 into a relatively compact and flat structure to facilitate storage when the invention 10 is not in use. A further folding-hinge-like device 28 may be attached to either or both sides of the pivotally attached generally transparent pane 12 and the reflective pane 13 to provide added stability to the combined structure when opened up for use.

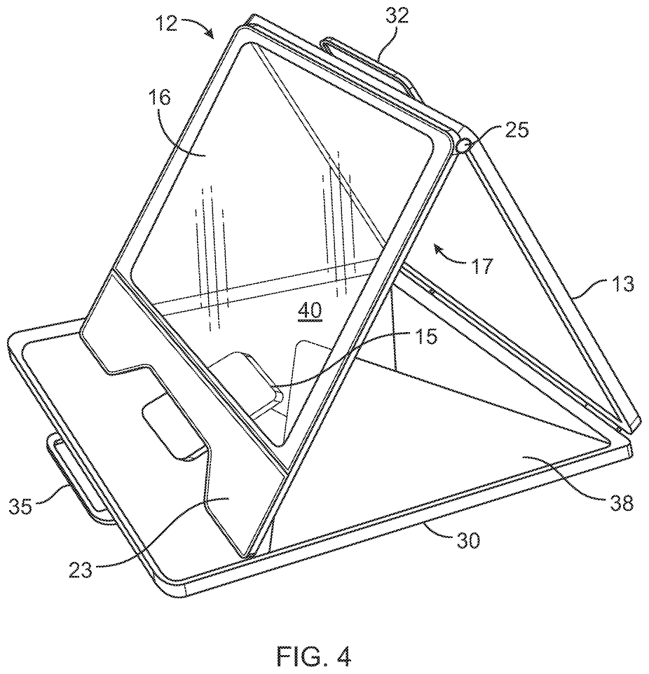

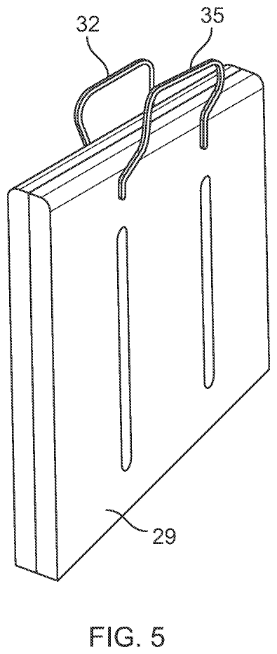

Yet another embodiment of the present invention 10 is illustrated in FIG. 4. This embodiment forms a self-contained unit which may be folded into itself to form a compact package 29 for ease of transport, as further illustrated in FIG. 5. In this embodiment the invention 10 further includes a base portion 30. This base portion 30, in combination with the reflective pane 12 may be employed to comprise outside covering surfaces, enclosing the generally reflective pane 12, when the invention 10 is folded up for transport. In this embodiment the base 30 is pivotally coupled to either of the generally transparent pane 12 or, alternatively, pivotally coupled to the reflective pane 13. In one embodiment the generally transparent pane 12 is pivotally coupled to the reflective pane 13 and the base 30 is pivotally coupled at one end thereof to a bottom portion of the reflective pane 13 opposite the end of the reflective pane 13 proximate the generally transparent pane 12 so as to form an apex with the generally transparent pane 12 when the invention is deployed or “opened up” for use. In an alternative embodiment, however, the generally transparent pane 12 and the reflective pane 13 are not coupled together but merely contact one another at the apex and the base 30 is pivotally attached to lower ends of both the generally reflective pane 12 and the reflective pane 13. In either of these two embodiments it is anticipated in operation that the generally transparent pane 12 would fold inwards and between the reflective pane 13 and the base 30 thereby allowing these latter two elements to afford protection to the generally transparent pane 12 when the invention 10 is folded up for transport or storage. The base 30 and reflective pane 13 may further each be equipped with handles 32, 35 illustrated in FIG. 4 and FIG. 5 for ease of carry of the invention 10 during transport.

Yet another embodiment of the present invention includes side panels 38 and 40 preferably, but not necessarily, pivotally coupled to the base portion 30 as shown in FIG. 5. When not in use these side panels 38 and 40 are folded down so as to lie generally flat on top of the base portion 30. In operation these side panels 38 and 40 are rotated into a generally vertical orientation to block ambient light from entering the space between the generally transparent pane 12, the reflective pane 13 and the base portion 30. The inventors have found the addition of the side panels 38 and 40 blocks entry of ambient light into the region of space between the generally transparent pane 12 and the reflective pane 13 thereby beneficially enhanceing the contrast of writing made by the lecturer 14 on the front facing surface 16 of the generally transparent pane 12.

In one presently preferred embodiment the invention 10 is configured as follows: the reflective pane 13 and the frame 17 attached to the generally transparent pane 12 are preferably dimensioned to be about 23 inches wide and about 22 inches tall with the base portion 30 being dimensioned about 23 inches wide and about 18 inches long. When deployed for use these dimensions afford an angle at the apex between the generally transparent pane 12 and the reflective pane 13 of about 48 degrees with the angles between the base portion 30 and respective edges of the generally transparent pane 12 and reflective pane 13 forming angles of about 66 degrees each. In this preferred embodiment the generally transparent pane 12 spans a region within the frame 17 of approximately 21 inches wide by about 12 inches wide. Of course, other dimensions could be employed without departing from the scope of the present invention and its claims.

The present invention provides a dramatic method and apparatus for the presentation of audio and visual information to either individuals or group audiences through broadcast, streaming, recording or live presentations while eliminating the problem of a lecturer having their back to their audience while writing down the visual portion of their presentation and without requiring use of a video production studio, additional lighting or dedicated video hardware. Having described and illustrated the present invention in various embodiments, it should be readily apparent to those skilled in the relevant arts that the present invention can be modified in arrangement and detail to provide numerous other embodiments that do not depart from the spirit and scope of this invention. Accordingly, all equivalent relationships to those illustrated in the drawings and described in the specification above are intended to be encompassed within the scope of the present invention, as set forth in the claims below and equivalents thereof.

It is to be further understood that the phraseology and terminology employed herein are for the purposes of description only and should not be regarded as limiting the scope of the present invention. Therefore, the foregoing description of the present invention is to be considered as illustrative only of the principles of the present invention. Further, since numerous modifications, changes and alternative embodiments will occur to those skilled in the art, the present invention is not to be limited to the structures, elements, construction and operation shown and described above, but solely by the claims set forth below and equivalents thereof.

What is claimed is:

1. Apparatus enabling audio and visual presentations by a lecturer using an imaging device, comprising:
a generally transparent pane, and
a reflective pane having one end disposed adjacent an end of the generally transparent pane to form an acute angle, wherein the lecturer is able to write written material on a surface of the generally transparent pane and, when the imaging device is oriented to image reflections of the written material and the lecturer off of the reflective pane, the written material is imaged with a legible left-to-right orientation.

2. The apparatus of claim 1 wherein the generally transparent pane is pivotally attached to one end of the generally transparent pane.

3. The apparatus of claim 1 further comprising a light source injecting light into an edge of the generally transparent pane.

4. The apparatus of claim 3 wherein the light source emits light of a wavelength predominantly about 405 nanometers.

5. The apparatus of claim 3 wherein the light source emits generally white light.

6. The apparatus of claim 3 wherein the light source emits generally white light and further comprising a blue filter disposed between the light source and the generally transparent pane to limit light injected into the generally transparent pane to predominantly about 405 nanometers.

7. The apparatus of claim 1 further comprising a base element contacting an end of the generally transparent pane and an end of the reflective pane.

8. The apparatus of claim 7 wherein the base pane is pivotally attached to one of the generally transparent pane and the reflective pane.

9. The apparatus of claim 7 further comprising a pair of side panels disposed approximately adjacent edges of the generally transparent pane and the reflective pane.

10. The apparatus of claim 9 wherein the side panels are pivotally connected to the base pane.

11. A method of presenting audio and visual material by a lecturer using an imaging device, comprising the steps of:
providing a generally transparent pane and a reflective pane disposed adjacent the generally transparent pane,
the lecturer making a presentation both verbally and by writing written material on a surface of the generally transparent screen facing the lecturer, and
imaging the lecturer making the presentation by orienting the imaging device to image a reflection of the lecturer and written material off of the reflective pane, wherein the reflection of the written material is imaged with a legible left-to-right orientation.

12. Apparatus enabling audio and visual presentations by a lecturer using an imaging device, comprising:
A generally transparent pane,
A reflective pane pivotally coupled to one end of the generally transparent screen, and
A base element contacting an end of the generally transparent pane and an end of the reflective pane and pivotally coupled to one of the generally transparent pane and the reflective pane.

13. The apparatus of claim 12 wherein the base pane is pivotally attached to one of the generally transparent pane and the reflective pane.

14. The apparatus of claim 12 further comprising a pair of side panels respectively disposed approximate adjacent edges of the generally transparent pane and the reflective pane.

15. The apparatus of claim 14 wherein the side panels are pivotally connected to the base element.

16. The apparatus of claim 10 further comprising a light source injecting light into an edge of the generally transparent pane.

17. The apparatus of claim 16 wherein the light source emits light of a wavelength predominantly about 405 nanometers.

18. The apparatus of claim 6 wherein the light source emits generally white light.

19. The apparatus of claim 16 wherein the light source emits generally white light and further comprising a blue filter disposed between the light source and the generally transparent pane to limit light injected into the generally transparent pane to predominantly about 405 nanometers.
